(19) United States
(12) Patent Application Publication
(10) Pub. No.: US 2026/0050293 A1
(43) Pub. Date: Feb. 19, 2026

(54) WINDOW, DISPLAY DEVICE INCLUDING THE SAME, AND ELECTRONIC DEVICE INCLUDING THE SAME

(71) Applicant: Samsung Display Co., Ltd., Yongin-si, (KR)

(72) Inventors: Jun Yeub LEE, Yongin-si, (KR); HOIKWAN LEE, Yongin-si, (KR); Yunyoung LEE, Yongin-si, (KR)

(21) Appl. No.: 19/290,856

(22) Filed: Aug. 5, 2025

(30) Foreign Application Priority Data
Aug. 14, 2024 (KR) 10-2024-0109221

(51) Int. Cl. G06F 1/16; G02B 1/11; G02B 1/14

(52) U.S. Cl. CPC G06F 1/1656; G02B 1/11; G02B 1/14; G06F 1/1641

(57) ABSTRACT

A display device includes a display panel which is foldable with respect to at least one folding axis, and a window disposed on the display panel. The window includes a base layer, and a hard coating layer disposed on the base layer, and the base layer includes an ester-based polymer and contains a silicon atom or a titanium atom.

This application claims priority to Korean Patent Application No. 10-2024-0109221, filed on Aug. 14, 2024, and all the benefits accruing therefrom under U.S.C. § 119, the content of which in its entirety is herein incorporated by reference.

### BACKGROUND

The present disclosure herein relates to a window, a display device including the same, and an electronic device including the same, and more particularly, to a foldable window, a display device including the same, and an electronic device including the same.

A display device provides information to a user by displaying various images on a display screen. Generally, a display device displays information within an allocated screen.

Recently, flexible display devices including a foldable flexible display panel are being developed. Such a flexible display device may be folded, rolled, or bent, unlike a rigid display device. A flexible display device deformable into various shapes is easy to carry regardless of existing display screen sizes, and thus user convenience may be improved.

### SUMMARY

The present disclosure provides a window with improved impact resistance and strength.

The present disclosure also provides a display device including the window with improved impact resistance and strength.

The present disclosure also provides an electronic device including the window with improved impact resistance and strength.

An embodiment of the invention provides a display device including: a display panel which is foldable with respect to at least one folding axis; and a window disposed on the display panel, wherein the window includes a base layer, and a hard coating layer disposed on the base layer, and the base layer includes an ester-based polymer and contains a silicon atom or a titanium atom.

In an embodiment, the base layer may have a thickness of about 10 micrometers (μm) to about 100 μm.

In an embodiment, the base layer may include polyethylene terephthalate (“PET”).

In an embodiment, the base layer may include polyethylene terephthalate having a silyl group as a terminal end group.

In an embodiment, the base layer may include a polymer synthesized with an ester-based monomer and a siloxane monomer.

In an embodiment, the base layer may include: a first material; and a second material dispersed in the first material, the first material may include polyethylene terephthalate, and the second material may include silicon oxide, silicon nitride, or titanium oxide.

In an embodiment, the second material may include silicon dioxide or titanium dioxide.

In an embodiment, the window may further include a window protective layer disposed on the hard coating layer.

In an embodiment, the window may further include a first window adhesive layer disposed between the hard coating layer and the window protective layer.

In an embodiment, the window may further include a lower inorganic layer directly disposed below the base layer.

In an embodiment, the lower inorganic layer may have a thickness of about 1 μm to about 100 μm.

In an embodiment, the lower inorganic layer may include silicon oxide, silicon nitride, or titanium oxide.

In an embodiment, the window may further include an upper inorganic layer directly disposed above the base layer.

In an embodiment, the upper inorganic layer may have a thickness of about 1 μm to about 100 μm.

In an embodiment, the upper inorganic layer may include silicon oxide, silicon nitride, or titanium oxide.

In an embodiment, the display device may further include an anti-reflection layer disposed between the display panel and the window.

In an embodiment, the display device may further include a second window adhesive layer disposed between the window and the anti-reflection layer.

In an embodiment, the display device may include: a folding region which is foldable with respect to the folding axis; and a non-folding region adjacent to the folding region.

In an embodiment of the invention, a window includes: a base layer; a hard coating layer disposed on the base layer; and an inorganic layer directly disposed above or below the base layer, wherein the base layer includes an ester-based polymer and contains a silicon atom or a titanium atom, and the inorganic layer includes a silicon atom or a titanium atom.

In an embodiment of the invention, an electronic device includes: a display panel which is foldable with respect to at least one folding axis; a window disposed on the display panel; and a housing configured to be coupled to the window and accommodate the display panel, wherein the window includes a base layer, and a hard coating layer disposed on the base layer, and the base layer includes an ester-based polymer and contains a silicon atom or a titanium atom.

### BRIEF DESCRIPTION OF THE FIGURES

The accompanying drawings are included to provide a further understanding of the invention, and are incorporated in and constitute a part of this specification. The drawings illustrate embodiments of the invention and, together with the description, serve to explain principles of the invention. In the drawings:

FIG. 1 is a perspective view of an electronic device according to an embodiment of the invention;

FIGS. 2A to 2D are views illustrating a state in which the electronic device illustrated in FIG. 1 is folded;

FIG. 3A is a perspective view illustrating a state in which an electronic device according to an embodiment of the invention is unfolded;

FIGS. 3B and 3C are views illustrating a state in which the electronic device illustrated in FIG. 3A is folded;

FIG. 4 is an exploded perspective view of an electronic device according to an embodiment of the invention;

FIG. 5 is a cross-sectional view of an upper module according to an embodiment of the invention;

FIG. 6 is a cross-sectional view of a window substrate according to an embodiment of the invention; and

FIGS. 7A to 7C are cross-sectional views of window substrates, respectively, according to other embodiments of the invention.

### DETAILED DESCRIPTION

In this specification, it will be understood that when an element (or region, layer, portion, or the like) is referred to as being “on”, “connected to” or “coupled to” another element, it may be directly disposed/connected/coupled to another element, or intervening elements may be disposed therebetween.

Like reference numerals or symbols refer to like elements throughout. Also, in the drawings, the thickness, the ratio, and the dimension of the elements are exaggerated for effective description of the technical contents. The term “and/or” includes all combinations of one or more of the associated listed elements.

Although the terms “first”, “second”, etc., may be used to describe various elements, these elements should not be limited by these terms. These terms are only used to distinguish one element from another element. For example, a first element may be referred to as a second element, and similarly, a second element may also be referred to as a first element without departing from the scope of the invention. The singular forms include the plural forms as well, unless the context clearly indicates otherwise.

Also, the terms such as “below”, “lower”, “above”, “upper” and the like, may be used for describing a relationship of elements illustrated in the figures. It will be understood that the terms have a relative concept and are described on the basis of the orientation depicted in the figures.

It will be understood that the term “includes” or “comprises”, when used in this specification, specifies the presence of stated features, integers, steps, operations, elements, components, or a combination thereof, but does not preclude the presence or addition of one or more other features, integers, steps, operations, elements, components, or combinations thereof.

Unless otherwise defined, all terms (including technical and scientific terms) used herein have the same meaning as commonly understood by one of ordinary skill in the art to which the present disclosure belongs. Also, terms, such as those defined in commonly used dictionaries, should be interpreted as having a meaning that is consistent with their meaning in the context of the relevant art and should not be interpreted in an idealized or overly formal sense unless expressly so defined herein.

Hereinafter, embodiments of the invention will be described with reference to the drawings.

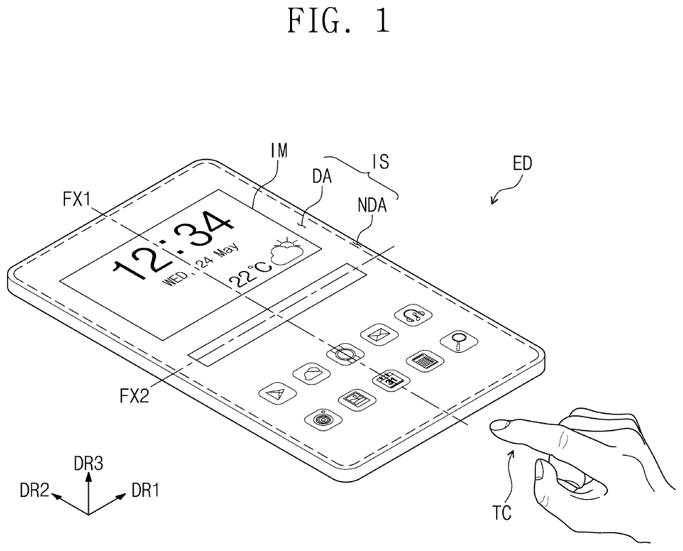

FIG. 1 is a perspective view of an electronic device according to an embodiment of the invention.

Referring to FIG. 1, an electronic device ED may be activated in response to an electrical signal. The electronic device ED may include various embodiments. For example, the electronic device ED may be used for a large-sized electronic device such as a television, a monitor, or an outdoor billboard, as well as a medium- and small-sized electronic device such as a personal computer, a laptop computer, a personal digital terminal, a car navigation unit, a game console, a mobile electronic apparatus, and a camera. In this embodiment, the electronic device ED is exemplarily illustrated as a smart phone.

The electronic device ED may have a rectangular shape which has a short side in a first direction DR1 and a long side in a second direction DR2 crossing the first direction DR1. However, a shape of the electronic device ED is not limited thereto, and the electronic devices ED having various shapes may be provided.

The electronic device ED may be a foldable electronic device. Specifically, the electronic device ED according to an embodiment of the invention may be folded with respect to a folding axis extending in a predetermined direction. Hereinafter, the electronic device ED which is flat without being folded is defined as being in a first state (that is, an unfolded state), and the electronic device ED which is folded with respect to the folding axis is defined as being in a second state (that is, a folded state). The folding axis is a rotation axis generated when the electronic device ED is folded, and may be provided by a mechanical structure of the electronic device ED.

The folding axis may extend in the first direction DR1 or the second direction DR2. In an embodiment of the invention, a folding axis extending in the second direction DR2 is defined as a first folding axis FX1, and a folding axis extending in the first direction DR1 is defined as a second folding axis FX2. The electronic device ED may include one folding axis among the first and second folding axes FX1 and FX2. That is, the electronic device ED may be folded with respect to one folding axis among the first and second folding axes FX1 and FX2.

As illustrated in FIG. 1, the electronic device ED may display an image IM on a display surface IS which is parallel to each of the first direction DR1 and the second direction DR2. The display surface IS on which the image IM is displayed may correspond to a front surface of the electronic device ED. A direction perpendicular to the display surface IS, that is, a thickness direction of the electronic device ED may be referred to as a third direction DR3. The electronic device ED may display the image IM in the third direction DR3.

The display surface IS of the electronic device ED may be divided into a plurality of regions. A display region DA and a non-display region NDA may be defined in the display surface IS of the electronic device ED.

The display region DA may be a region on which the image IM is displayed, and the image IM is viewed by a user through the display region DA. The display region DA may have a quadrilateral shape. The non-display region NDA is a region which is adjacent to the display region DA, and on which the image IM is not displayed. A bezel region of the electronic device ED may be defined by the non-display region NDA. As an example of the invention, the non-display region NDA may surround the display region DA. Accordingly, a shape of the display region DA may be substantially defined by the non-display region NDA. However, this is illustrated as an example, and the non-display region NDA may not only be disposed adjacent to only one side of the display region DA but also be omitted.

The electronic device ED according to the invention may sense a user's input TC applied from the outside. The user's input TC includes various types of external inputs such as a part of a user's body, light, heat, or pressure. In this embodiment, the user's input TC is illustrated as a user's hand which is applied to a front surface of the electronic device ED. However, this is illustrated as an example, and as described above, the user's input TC may be provided in various forms. Additionally, the electronic device ED may also detect the user's input TC which is applied to a side surface or a rear surface of the electronic device ED according to a configuration of the electronic device ED, and is not limited to any one embodiment.

The electronic device ED may activate the display surface IS to display the image IM and simultaneously detect the user's input TC. In this embodiment, a region for sensing the user's input TC is illustrated to be provided in the display region DA in which the image IM is displayed. However, this is illustrated as an example, and the region for sensing the user's input TC may be provided not only in the non-display region NDA but also in the entire region of the display surface IS.

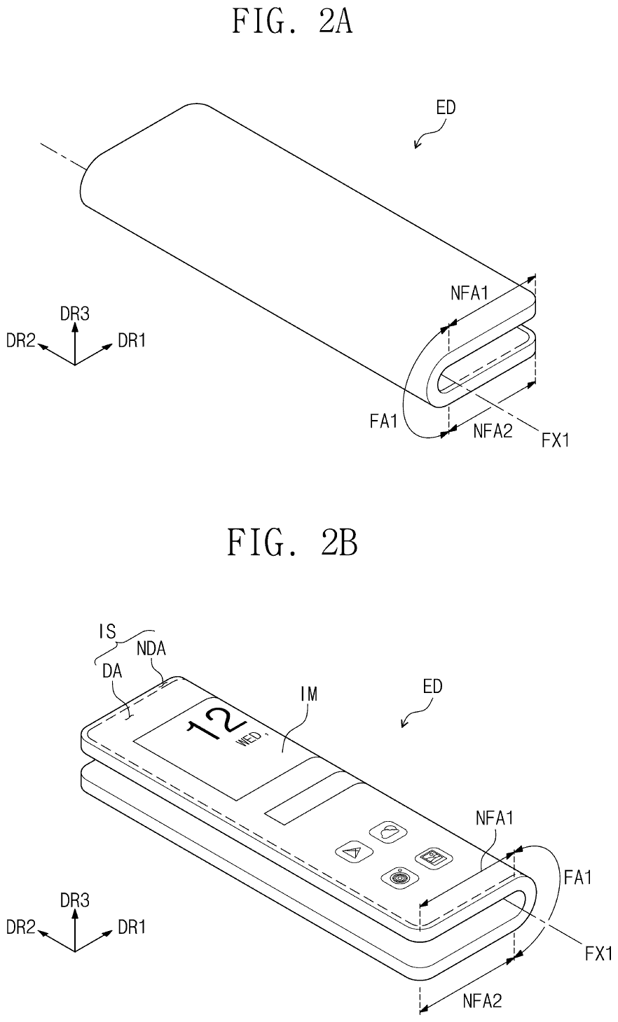

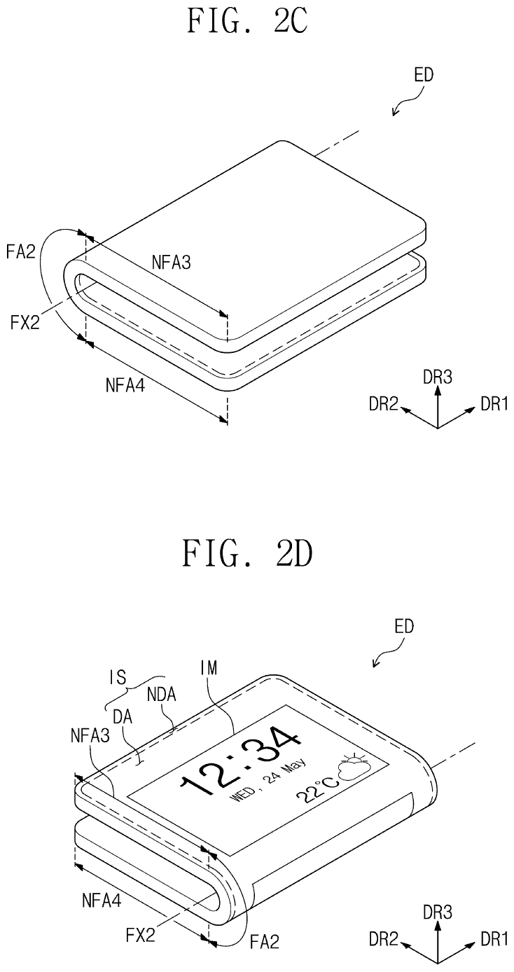

FIGS. 2A to 2D are views illustrating a state in which the electronic device illustrated in FIG. 1 is folded.

FIG. 2A is a view illustrating a state in which the electronic device ED illustrated in FIG. 1 is in-folded with respect to the first folding axis FX1, and FIG. 2B is a view illustrating a state in which the electronic device ED illustrated in FIG. 1 is out-folded with respect to the first folding axis FX1.

FIG. 2C is a view illustrating a state in which the electronic device ED illustrated in FIG. 1 is in-folded with respect to the second folding axis FX2, and FIG. 2D is a view illustrating a state in which the electronic device ED illustrated in FIG. 1 is out-folded with respect to the second folding axis FX2.

Referring to FIGS. 2A to 2D, the electronic device ED may be a foldable electronic device. The electronic device ED may be folded with respect to a folding axis, that is, the first folding axis FX1 or the second folding axis FX2 extending in a predetermined direction.

Referring to FIGS. 2A and 2B, a plurality of regions may be defined in the electronic device ED according to an operation type of the electronic device ED. The plurality of regions may be divided into at least one folding region FA1, and non-folding regions NFA1 and NFA2. The folding region FA1 is defined between two non-folding regions NFA1 and NFA2.

The folding region FA1 is a region which is folded with respect to the first folding axis FX1 and substantially forms a curvature. Here, the first folding axis FX1 may extend along the second direction DR2, that is, a long-axis direction of the electronic device ED. The folding region FA1 is defined as a region which is folded with respect to the first folding axis FX1 and extends along the second direction DR2.

As an example of the invention, the non-folding regions NFA1 and NFA2 may include a first non-folding region NFA1 and a second non-folding region NFA2. The first non-folding region NFA1 is adjacent to one side of the folding region FA1 in the first direction DR1, and the second non-folding region NFA2 is adjacent to the other side of the folding region FA1 in the first direction DR1.

The electronic device ED may be in-folded or out-folded. A state of the electronic device ED being folded such that different display surfaces of the non-folding regions NFA1 and NFA2 face each other is defined as an in-folding, and a state of the electronic device ED being folded such that different display surfaces of the non-folding regions NFA1 and NFA2 are disposed towards the outside is defined as an out-folding.

In this case, the in-folding indicates that the electronic device ED is folded such that regions of the display surface IS face each other, and the out-folding indicates that the electronic device ED is folded such that regions of a rear surface face each other.

The electronic device ED illustrated in FIG. 2A may be in-folded such that the display surface IS (see FIG. 1) of the first non-folding region NFA1 and the display surface IS (see FIG. 1) of the second non-folding region NFA2 face each other. As the first non-folding region NFA1 rotates clockwise along the first folding axis FX1, the electronic device ED may be in-folded. The first folding axis FX1 may be defined at a center of the electronic device ED along the first direction DR1 such that the electronic device ED is in-folded to align the first non-folding region NFA1 with the second non-folding region NFA2.

Referring to FIG. 2B, the electronic device ED may be out-folded with respect to the first folding axis FX1. The electronic device ED may display the image IM when the display surface of the first non-folding region NFA1 and the display surface of the second non-folding region NFA2 are exposed to the outside. Additionally, the display surface of the folding region FA1 exposed to the outside may display the image IM. As illustrated in FIG. 1, the electronic device ED in an unfolded state may display the image IM. The first non-folding region NFA1, the second non-folding region NFA2, and the folding region FA1 may display images for providing independent information, or display portions of a single image for providing a piece of information, respectively.

The electronic device ED may be manufactured so as to be in both an in-folded state and an out-folded state, or may be manufactured to be in either of an in-folded state or an out-folded state.

Referring to FIGS. 2C and 2D, the electronic device ED may be in-folded or out-folded with respect to the second folding axis FX2. The second folding axis FX2 may extend along the first direction DR1, that is, a short-axis direction of the electronic device ED.

A plurality of regions may be defined in the electronic device ED according to operation types. The plurality of regions may be divided into at least one folding region FA2, and non-folding regions NFA3 and NFA4. The folding region FA2 is defined between the two non-folding regions NFA3 and NFA4.

The folding region FA2 is a region which is folded with respect to the second folding axis FX2 and substantially forms a curvature. The folding region FA2 is defined as a region which is folded with respect to the second folding axis FX2 and extends along the first direction DR1.

As an example of the invention, the non-folding regions NFA3 and NFA4 may include a first non-folding region NFA3 and a second non-folding region NFA4. The first non-folding region NFA3 is adjacent to one side of the folding region FA2 in the second direction DR2, and the second non-folding region NFA4 is adjacent to the other side of the folding region FA2 in the second direction DR2.

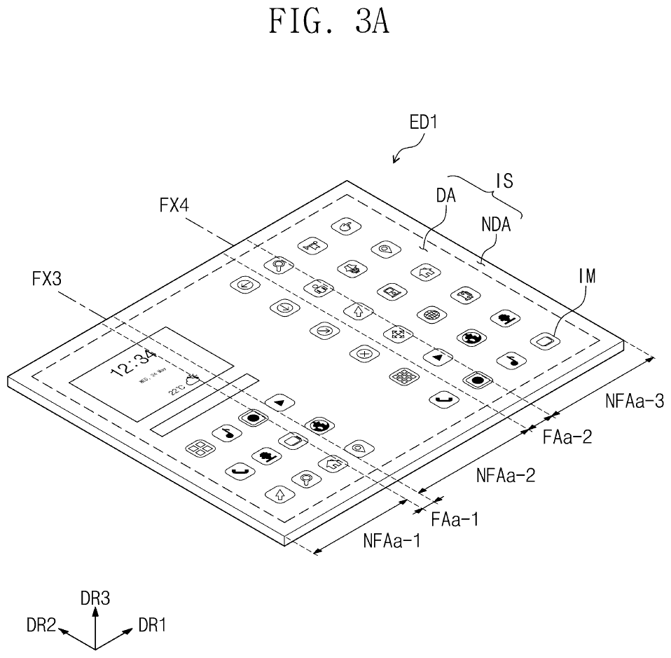

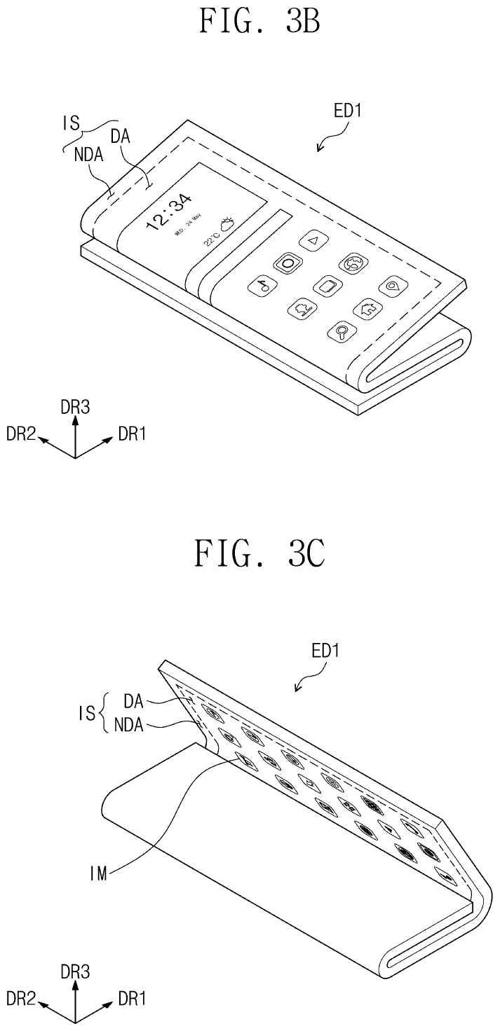

FIG. 3A is a perspective view illustrating a state in which an electronic device according to an embodiment of the invention is unfolded. FIGS. 3B and 3C are views illustrating a state in which the electronic device illustrated in FIG. 3A is multi-folded.

Referring to FIGS. 3A to 3C, an electronic device ED1 may be a multi-foldable electronic device. A plurality of folding regions may be defined in the electronic device ED1. The electronic device ED1 may include a plurality of folding regions FAa-1 and FAa-2, and a plurality of non-folding regions NFAa-1, NFAa-2, and NFAa-3. As an example of the invention, the electronic device ED1 may include a first folding region FAa-1, a second folding region FAa-2, a first non-folding region NFAa-1, a second non-folding region NFAa-2, and a third non-folding region NFAa-3. In the first direction DR1, the first folding region FAa-1 is disposed between the first non-folding region NFAa-1 and the second non-folding region NFAa-2, and the second folding region FAa-2 is disposed between the second non-folding region NFAa-2 and the third non-folding region NFAa-3. The two folding regions FAa-1 and FAa-2, and the three non-folding regions NFAa-1, NFAa-2, and NFAa-3 are exemplarily illustrated. However, the number of the folding regions FAa-1 and FAa-2, and the non-folding regions NFAa-1, NFAa-2, and NFAa-3 is not limited thereto, and may further increase.

Referring to FIGS. 3A and 3B, the first folding region FAa-1 may be folded with respect to a third folding axis FX3 parallel to the second direction DR2. The first folding region FAa-1 may be in-folded such that a display surface of the second non-folding region NFAa-2 and a display surface of the first non-folding region NFAa-1 face each other. The second folding region FAa-2 may be folded with respect to a fourth folding axis FX4 parallel to the second direction DR2. The second folding region FAa-2 may be out-folded such that a rear surface of the second non-folding region NFAa-2 and a rear surface of the third non-folding region NFAa-3 face each other, and a display surface of the third non-folding region NFAa-3 is disposed towards the outside.

Referring to FIGS. 3A and 3C, the first folding region FAa-1 may be folded with respect to the third folding axis FX3 parallel to the second direction DR2. The first folding region FAa-1 may be in-folded such that a display surface of the first non-folding region NFAa-1 is disposed inside and a display surface of the second non-folding region NFAa-2 and the display surface of the first non-folding region NFAa-1 face each other. The second folding region FAa-2 may be folded with respect to the fourth folding axis FX4 parallel to the second direction DR2. The second folding region FAa-2 may be in-folded such that a rear surface of the first non-folding region NFAa-1 and a display surface of the third non-folding region NFAa-3 face each other.

In an embodiment of the invention, the out-folding operation and the in-folding operation may be performed at the same time, and either of the out-folding operation or the in-folding operation may be performed.

FIGS. 3B and 3C illustrate a state in which the electronic device ED1 is multi-folded, but an embodiment of the invention is not limited thereto. The electronic device ED1 may have various folding types.

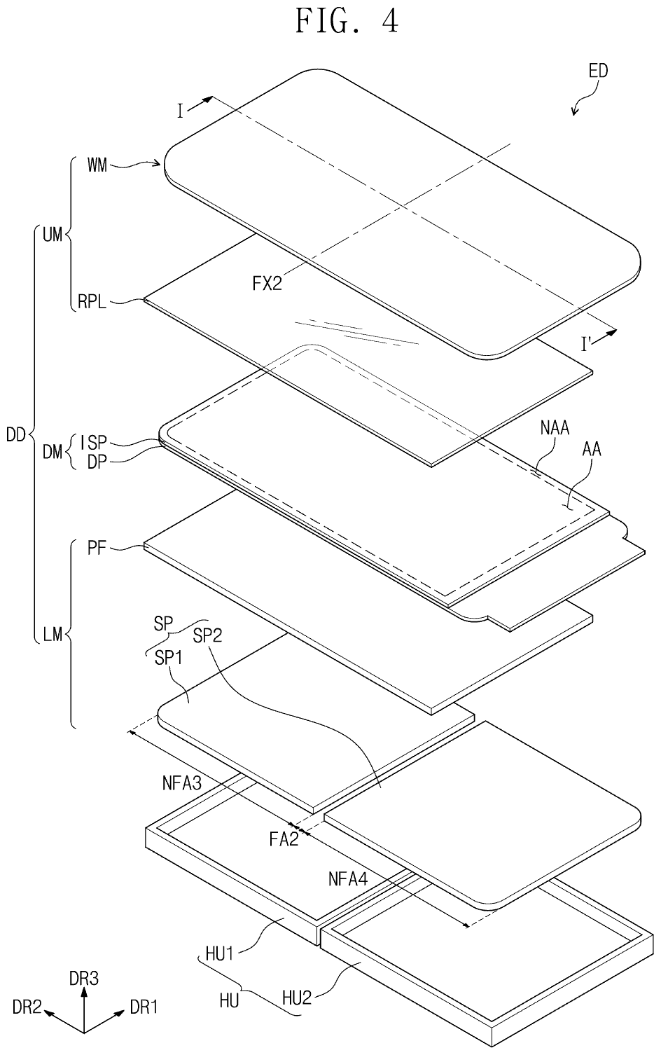

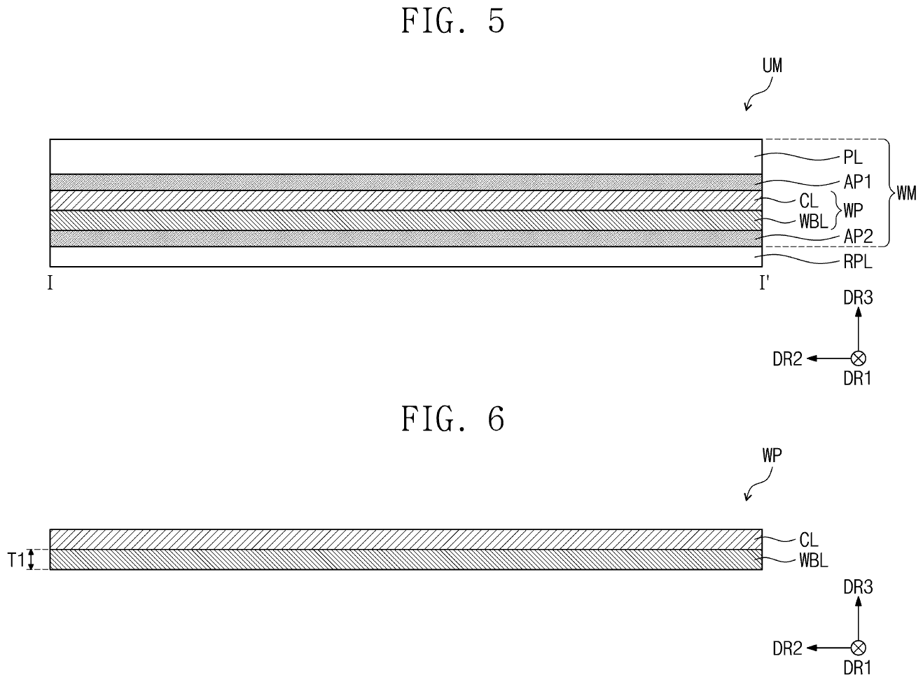

FIG. 4 is an exploded perspective view of an electronic device according to an embodiment of the invention, and FIG. 5 is a cross-sectional view of an upper module according to an embodiment of the invention. FIG. 5 illustrates in more detail a cross section of the upper module taken along line I-I′ illustrated in FIG. 4.

Referring to FIGS. 4 and 5, an electronic device ED according to an embodiment of the invention includes a display device DD and a housing HU. Although not illustrated, the electronic device ED may further include a mechanical structure (for example, a hinge structure) for controlling a folding operation (or a bending operation) of the display device DD.

The display device DD according to an embodiment of the invention may include a display module DM which displays images, an upper module UM disposed on the display module DM, and a lower module LM disposed below the display module DM. The display module DM may constitute a part of the display device DD, and particularly, images may be generated by the display module DM.

The display module DM may include a display panel DP and an input-sensing unit ISP. The display panel DP according to an embodiment of the invention may be a light-emitting display panel, and is not particularly limited. For example, the display panel DP may be an organic light-emitting display panel, an inorganic light-emitting display panel, or a quantum dot light-emitting display panel. A light-emitting layer of the organic light-emitting display panel may include an organic light-emitting material, and a light-emitting layer of the inorganic light-emitting display panel may include an inorganic light-emitting material. A light-emitting layer of the quantum dot light-emitting display panel may include quantum dots, quantum rods, etc. Hereinafter, the display panel DP is described as an organic light-emitting display panel.

The display panel DP may be a flexible display panel. Accordingly, the display panel DP may be entirely rolled, or folded or unfolded with respect to the folding axis FX2.

The input-sensing unit ISP may be directly disposed on the display panel DP. According to an embodiment of the invention, the input-sensing unit ISP may be formed on the display panel DP through a continuous manufacturing process. That is, when the input-sensing unit ISP is directly disposed on the display panel DP, an adhesive film is not disposed between the input-sensing unit ISP and the display panel DP. However, an embodiment of the invention is not limited thereto. An adhesive film may be disposed between the input-sensing unit ISP and the display panel DP in another embodiment. In this case, the input-sensing unit ISP and the display panel DP are not manufactured through a continuous manufacturing process, but the input-sensing unit ISP may be manufactured through a separate process from the display panel DP, and then may be fixed on an upper surface of the display panel DP by the adhesive film.

The display panel DP generates images, and the input-sensing unit ISP acquires coordinate information about a user's input (for example, touch event).

The upper module UM may include a window WM disposed on the display module DM. The window WM may include an optically transparent insulating material. Accordingly, images generated from the display module DM pass through the window WM, and may thus be easily recognized by a user. The window WM may be the outermost part of the electronic device ED (or the display device DD).

The window WM may include a window substrate WP and a window protective layer PL. The window substrate WP according to an embodiment of the invention may include a base layer WBL and a hard coating layer CL. The details of the base layer WBL and the hard coating layer CL will be described below with reference to FIG. 6.

The window protective layer PL may be disposed on the window substrate WP. The window protective layer PL may be provided on a first resin layer RS1. The window protective layer PL may perform a function of protecting the window substrate WP against an external impact. The window protective layer PL may include a synthetic resin material. As an example of the invention, the window protective layer PL may include at least one selected from a urethane-based resin, an epoxy-based resin, a polyester-based resin, a polyether-based resin, an acrylate-based resin, an acrylonitrile-butadiene-styrene (“ABS”) resin, and rubber. Specifically, the window protective layer PL may include at least one of phenylene, polyethylene terephthalate (PET), polyimide (“PI”), polyamide (“PAI”), polyethylene naphthalate (“PEN”), or polycarbonate (“PC”).

The window WM may further include a first window adhesive layer AP1 and a second window adhesive layer AP2. The first window adhesive layer AP1 may be disposed between the window substrate WP and the window protective layer PL and attach the window protective layer PL to the window substrate WP. The first window adhesive layer AP1 may have a thickness of about 20 micrometers (μm) to about 50 μm. The first window adhesive layer AP1 may have a thickness of about 30 μm to about 40 μm. The second window adhesive layer AP2 may bond a member disposed below the window WM and the window WM. For example, the second window adhesive layer AP2 may bond an anti-reflection layer RPL disposed below the window WM and the window WM. The second window adhesive layer AP2 may have a thickness of about 10 μm to about 100 μm. The first window adhesive layer AP1 may have a thickness of about 40 μm to about 60 μm. The first window adhesive layer AP1 and the second window adhesive layer AP2 may each include an optically transparent adhesive material. For example, the first window adhesive layer AP1 and the second window adhesive layer AP2 may each include a pressure sensitive adhesive (“PSA”), an optical clear adhesive (“OCA”), or an optical clear resin (“OCR”).

Although not illustrated, the window WM may further include an additional coating layer disposed on the uppermost part thereof. In an embodiment, the additional coating layer may include an adhesive force enhancing layer including polysilazane. Alternatively, the additional coating layer may include an anti-fingerprint layer including a hydrophobic material. However, the embodiment is not limited thereto.

The window WM may be folded or unfolded with respect to the folding axis FX2. That is, when a shape of the display module DM is deformed, a shape of the window WM may be deformed together. The window WM reduces external impact as well as allows the image from the display module DM to pass therethrough, and thus prevents the display module DM from being damaged or malfunctioning due to external impact. The external impact may be a force from the outside which may be expressed as a pressure, a stress, etc., and mean a force which causes defects of the display module DM.

Additionally, the upper module UM may further include one or more functional layers disposed between the display module DM and the window WM. As an example of the invention, the functional layer may be an anti-reflection layer RPL which blocks reflection for external light.

The anti-reflection layer RPL may prevent elements constituting the display module DM from being viewed from the outside due to external light incident through a front surface of the display device DD. The anti-reflection layer RPL may include a retarder and a polarizer. The retarder may be a film type or a liquid crystal coating type, and may include a λ/2 retarder and/or a λ/4 retarder. The polarizer may also be a film type or a liquid crystal coating type. The film type may include a stretched synthetic resin film, and the liquid crystal coating type may include liquid crystals arranged in a predetermined arrangement. The retarder and polarizer may be formed as one polarizing film. The functional layer may further include a protective film disposed above or below the anti-reflection layer RPL.

The display module DM may display images in response to an electrical signal, and transmit/receive information about an external input. The display module DM may include an active region AA and a peripheral region NAA. The active region AA may be defined as a region in which images provided from the display module DM are displayed.

The peripheral region NAA is adjacent to the active region AA. For example, the peripheral region NAA may surround the active region AA. However, this is illustrated as an example. The peripheral region NAA may be defined as having various shapes, and is not limited to any one embodiment. According to an embodiment, the active region AA of the display module DM may correspond to at least a portion of the display region DA (see FIG. 1).

The lower module LM includes a support plate SP which is disposed on a rear surface of the display module DM and supports the display module DM. The support plate SP may include support plates the number of which corresponds to the number of the non-folding regions NFA3 and NFA4. As an example of the invention, the support plate SP may include a first support plate SP1 and a second support plate SP2 disposed to be spaced apart from the first support plate SP1.

The first and second support plates SP1 and SP2 may be disposed to correspond to the first and second non-folding regions NFA3 and NFA4, respectively. The first support plate SP1 is disposed to correspond to the first non-folding region NFA3 of the display module DM, and the second support plate SP2 is disposed to correspond to the second non-folding region NFA4 of the display module DM. The first and second support plates SP1 and SP2 may each include a metal material or a plastic material.

When the display module DM is in a first state of being unfolded, the first and second support plates SP1 and SP2 are disposed to be spaced apart from each other in the second direction DR2. When the display module DM is in a second state of being folded with respect to the folding axis FX2, the first and second support plates SP1 and SP2 may be disposed to be spaced apart from each other in the third direction DR3.

The first and second support plates SP1 and SP2 may be spaced apart from each other, corresponding to the folding region FA2. The first and second support plates SP1 and SP2 may partially overlap the folding region FA2. That is, in the second direction DR2, a spacing distance between the first support plate SP1 and the second support plate SP2 may be smaller than a width of the folding region FA2.

The support plate SP may further include a connection module for connecting the first and second support plates SP1 and SP2. The connection module may include a hinge module or an articulated module.

It is illustrated that the support plate SP includes two support plates SP1 and SP2, but an embodiment of the invention is not limited thereto. That is, when a plurality of folding axes FX2 are provided, the support plate SP may be provided with a plurality of support plates separated with respect to the plurality of folding axes FX2. Alternatively, the support plate SP may not be separated into the first and second support plates SP1 and SP2, but may be provided as an integrated shape. In this case, a bending portion may be provided to the support plate SP, corresponding to the folding region FA2. The bending portion may be provided with an opening formed by penetrating the support plate SP or may be provided with a groove recessed from one surface of the support plate SP.

The lower module LM further includes a protective film PF disposed between the display module DM and the support plate SP. The protective film PF may be disposed below the display module DM, and may protect a rear surface of the display module DM. The protective film PF may include a synthetic resin film, for example, a polyimide (PI) film or a polyethylene terephthalate (PET) film. However, this is presented as an example, and the protective film PF is not limited thereto.

The housing HU is coupled to the display device DD, specifically, to the window WM, and accommodates other modules described above (that is, the display module DM, the lower module LM, etc.). It is illustrated that the housing HU includes first and second housings HU1 and HU2 separated from each other, but an embodiment of the invention is not limited thereto. Although not illustrated, the electronic device ED may further include a hinge structure for connecting the first and second housings HU1 and HU2.

Hereinafter, the window substrate WP according to an embodiment of the invention will be described in more detail with reference to the accompanying drawings.

FIG. 6 is a cross-sectional view of a window substrate according to an embodiment of the invention. In FIG. 6, a window substrate WP among the components of the window WM illustrated in FIG. 5 is illustrated in more detail.

Referring to FIG. 6, the window substrate WP includes a base layer WBL and a hard coating layer CL. The hard coating layer CL is disposed on the base layer WML. The hard coating layer CL may be directly disposed on the base layer WML.

The base layer WBL includes an ester-based polymer. The base layer WBL may include polyethylene terephthalate. The base layer WBL may include polyethylene terephthalate having a silyl group as a terminal end group. The base layer WBL contains a silicon atom or a titanium atom. In an embodiment, the base layer WBL may contain a titanium atom. Alternatively, the base layer WBL may include a polymer synthesized with an ester-based monomer and a siloxane monomer. For example, the base layer WBL may include a polymer formed by polymerizing terephthalic acid, ethylene glycol, and a siloxane monomer.

The base layer WBL may include a first material including an ester-based polymer, and a second material dispersed in the first material. In this case, the first material may include polyethylene terephthalate, and the second material may include silicon oxide, silicon nitride, or titanium oxide. For example, the second material may include silicon dioxide or titanium dioxide. The second material may be a filler of a sol, a nano silica sol, or a porous sol. The filler may have spherical shape, and have substantially a monodispersed size distribution, or a polydisperse distribution obtained by mixing particles having a monodisperse distribution. For example, the plurality of particles included in the filler may have an average particle size of about nanometers (nm) to about 50 nm. The average size of the plurality of particles included in the filler may represent the average diameter of the filler. For example, the plurality of particles included in the filler may have an average diameter of about nm to about 30 nm. However, an embodiment of the invention is not limited thereto, and the filler may have various shapes.

The base layer WBL may have a thickness T1 of about 10 μm to about 100 μm. For example, the base layer WBL may have a thickness T1 of about 20 μm to about 40 μm.

The hard coating layer CL may include a siloxane-based polymer, an acrylate-based polymer, an epoxy-based polymer, or a urethane-based polymer. The material included in the hard coating layer CL may differ from the material included in the base layer WBL. The hard coating layer CL may include a UV-curable resin. The hard coating layer CL may be formed of or include a resin having a viscosity of about 100 centipoise (cps) to about 2000 cps. For example, the hard coating layer CL may include a siloxane compound. In an embodiment, the hard coating layer CL may include materials such as polymethylsiloxane and polydimethylsiloxane. In an embodiment, the siloxane compound included in the hard coating layer CL may be a siloxane polymer compound or a siloxane oligomer derived from a siloxane monomer having a functional group such as an acrylate group at the terminal thereof. In an embodiment, the siloxane compound may be a siloxane polymer formed by polymerization of silsesquioxane with a siloxane monomer.

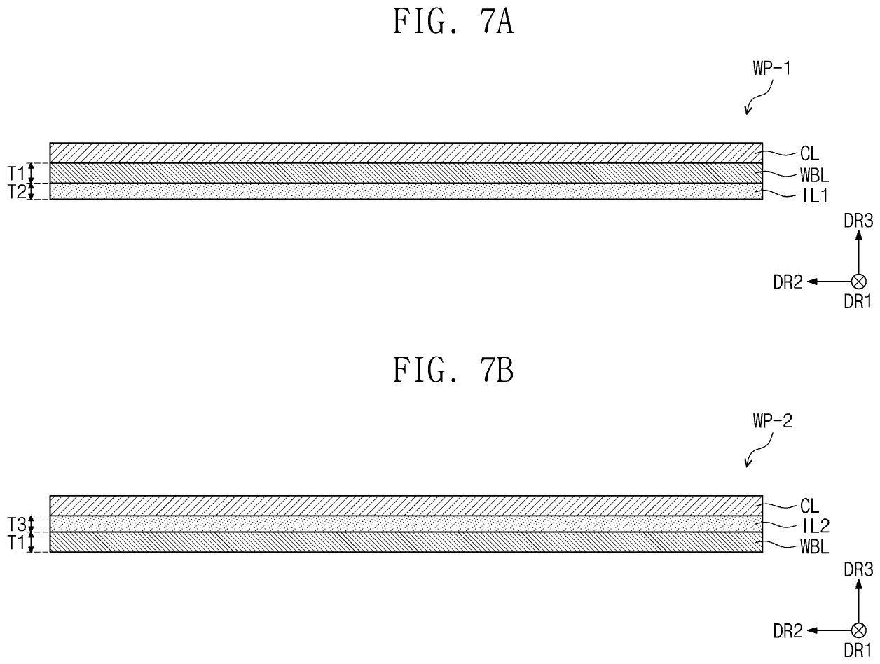

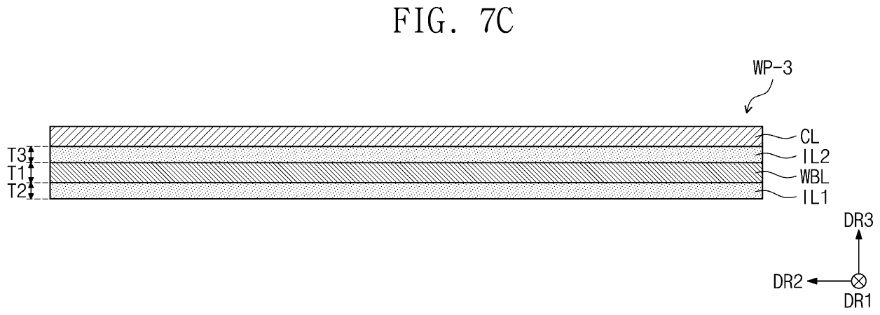

FIGS. 7A to 7C are cross-sectional views of window substrates, respectively, according to other embodiments of the invention. FIGS. 7A to 7C illustrate cross sections of window substrates WP-1, WP-2, and WP-3, respectively, corresponding to the cross section of FIG. 6 according to other embodiments different from each other.

Referring to FIGS. 7A to 7C, the window substrates WP-1, WP-2, and WP-3 may each include a base layer WBL and a hard coating layer CL, and further include inorganic layers IL1 and IL2. The inorganic layers IL1 and IL2 may include a lower inorganic layer IL1 disposed below the base layer WBL and an upper inorganic layer IL2 disposed above the base layer WBL. Compared to the above-described FIG. 6, FIG. 7A illustrates that the window substrate WP-1 according to an embodiment further includes the lower inorganic layer IL1, FIG. 7B illustrates that the window substrate WP-2 according to an embodiment further includes the upper inorganic layer IL2, and FIG. 7C illustrates that the window substrate WP-3 according to an embodiment includes both the lower inorganic layer IL1 and the upper inorganic layer IL2.

Referring to FIGS. 7A and 7C, the window substrates WP-1 and WP-3 may include the lower inorganic layer IL1. The lower inorganic layer IL1 may be directly disposed below the base layer WBL.

The lower inorganic layer IL1 may include silicon oxide, silicon nitride, or titanium oxide. For example, the lower inorganic layer IL1 may include silicon dioxide or titanium dioxide. The material included in the lower inorganic layer IL1 may be the same as the material included in the base layer WBL. However, an embodiment of the invention is not limited thereto, and in another embodiment, the material included in the lower inorganic layer IL1 may also differ from the material included in the base layer WBL. For example, the lower inorganic layer IL1 may not include an ester-based polymer (e.g., polyethylene terephthalate (PET)) while including silicon oxide, silicon nitride, or titanium oxide.

The lower inorganic layer IL1 may have a thickness T2 of about 1 μm to about 100 μm. For example, the lower inorganic layer IL1 may have a thickness T2 of about 1 μm to about 50 μm. The thickness T2 of the lower inorganic layer IL1 may be smaller than the thickness T1 of the base layer WBL. The lower inorganic layer IL1 may be a thin film formed through a plasma enhanced chemical vapor deposition (“PECVD”) process, a sputtering process, or an atomic layer deposition (“ALD”) process.

Referring to FIGS. 7B and 7C, the window substrates WP-2 and WP-3 may include the upper inorganic layer IL2. The upper inorganic layer IL2 may be directly disposed above the base layer WBL.

The upper inorganic layer IL2 may include silicon oxide, silicon nitride, or titanium oxide. For example, the upper inorganic layer IL2 may include silicon dioxide or titanium dioxide. The material included in the upper inorganic layer IL2 may be the same as the material included in the lower inorganic layer IL1. The material included in the upper inorganic layer IL2 may be the same as the material included in the base layer WBL. However, an embodiment of the invention is not limited thereto, and in another embodiment, the material included in the upper inorganic layer IL2 may also differ from the material included in the base layer WBL or the lower inorganic layer IL1. For example, the upper inorganic layer IL2 may not include an ester-based polymer (e.g., polyethylene terephthalate (PET)) while including silicon oxide, silicon nitride, or titanium oxide.

The upper inorganic layer IL2 may have a thickness T3 of about 1 μm to about 100 μm. For example, the upper inorganic layer IL2 may have a thickness T3 of about 1 μm to about 50 μm. The thickness T3 of the upper inorganic layer IL2 may be the substantially same as the thickness T2 of the lower inorganic layer IL1. Meanwhile, in this specification, the wording “the substantially same” includes not only a case where components have completely the physically same thickness, etc., but also a case where in spite of being identically designed, components have a difference in thicknesses, etc., by tolerances which occur during a process. However, an embodiment of the invention is not limited thereto, and in another embodiment, the thickness T3 of the upper inorganic layer IL2 may also differ from the thickness T2 of the lower inorganic layer IL1. The thickness T3 of the upper inorganic layer IL2 may be smaller than the thickness T1 of the base layer WBL. The upper inorganic layer IL2 may be a thin film formed through a plasma enhanced chemical vapor deposition (PECVD) process, a sputtering process, or an atomic layer deposition (ALD) process.

Recently, as flexible display devices including a foldable flexible display panel are being developed, a window has a thinner thickness, which causes a decrease in reliability due to reduced modulus and strength. Since a base layer of a window according to an embodiment of the invention includes an ester-based polymer and contains a silicon atom or a titanium atom, modulus and strength of the window are improved in spite of the thin thickness, and thus a display device may have improved reliability (e.g., durability, strength). The window according to an embodiment of the invention further contains a silicon atom or a titanium atom compared to the typical window in which a single layer of polyethylene terephthalate film is used as a base layer, thereby making it possible to effectively improve impact resistance, modulus and strength. Also, an inorganic layer being in contact with a lower surface or an upper surface of the base layer is additionally disposed, and thus impact resistance, modulus and strength may be improved. Therefore, a display device including the window according to an embodiment of the invention, and an electronic device including the window according to an embodiment of the invention may have improved reliability.

A window according to an embodiment of the invention may include a base layer including an ester-based polymer and containing a silicon atom or a titanium atom, thereby having improved modulus and strength.

A display device according to an embodiment of the invention may include a base layer including an ester-based polymer and containing a silicon atom or a titanium atom, thereby having improved reliability.

An electronic device according to an embodiment of the invention may include a base layer including an ester-based polymer and containing a silicon atom or a titanium atom, thereby having improved reliability.

Although the embodiments of the invention have been described, it is understood that the invention should not be limited to these embodiments but various changes and modifications can be made by one ordinary skilled in the art within the spirit and scope of the invention as hereinafter claimed. Therefore, the technical scope of the invention is not limited to the contents described in the detailed description of the specification, but should be determined by the claims.

What is claimed is:

1. A display device comprising:
a display panel which is foldable with respect to at least one folding axis; and
a window disposed on the display panel,
wherein the window includes
a base layer, and
a hard coating layer disposed on the base layer, and
the base layer includes an ester-based polymer and contains a silicon atom or a titanium atom.

2. The display device of claim 1, wherein the base layer has a thickness of about 10 micrometers (μm) to about 100 μm.

3. The display device of claim 1, wherein the base layer comprises polyethylene terephthalate (PET).

4. The display device of claim 1, wherein the base layer comprises polyethylene terephthalate having a silyl group as a terminal end group.

5. The display device of claim 1, wherein the base layer comprises a polymer synthesized with an ester-based monomer and a siloxane monomer.

6. The display device of claim 1, wherein the base layer comprises:
a first material; and
a second material dispersed in the first material,
the first material includes polyethylene terephthalate, and
the second material includes silicon oxide, silicon nitride, or titanium oxide.

7. The display device of claim 6, wherein the second material comprises silicon dioxide or titanium dioxide.

8. The display device of claim 1, wherein the window further comprises a window protective layer disposed on the hard coating layer.

9. The display device of claim 8, wherein the window further comprises a first window adhesive layer disposed between the hard coating layer and the window protective layer.

10. The display device of claim 1, wherein the window further comprises a lower inorganic layer directly disposed below the base layer.

11. The display device of claim 10, wherein the lower inorganic layer has a thickness of about 1 μm to about 100 μm.

12. The display device of claim 10, wherein the lower inorganic layer comprises silicon oxide, silicon nitride, or titanium oxide.

13. The display device of claim 1, wherein the window further comprises an upper inorganic layer directly disposed above the base layer.

14. The display device of claim 13, wherein the upper inorganic layer has a thickness of about 1 μm to about 100 μm.

15. The display device of claim 13, wherein the upper inorganic layer comprises silicon oxide, silicon nitride, or titanium oxide.

16. The display device of claim 1, further comprising an anti-reflection layer disposed between the display panel and the window.

17. The display device of claim 16, further comprising a second window adhesive layer disposed between the window and the anti-reflection layer.

18. The display device of claim 1, comprising:
a folding region which is foldable with respect to the folding axis; and
a non-folding region adjacent to the folding region.

19. A window comprising:
a base layer;
a hard coating layer disposed on the base layer; and
an inorganic layer directly disposed above or below the base layer,
wherein the base layer includes an ester-based polymer and contains a silicon atom or a titanium atom, and
the inorganic layer includes a silicon atom or a titanium atom.

20. An electronic device comprising:
a display panel which is foldable with respect to at least one folding axis;
a window disposed on the display panel; and
a housing coupled to the window and accommodating the display panel,
wherein the window includes
a base layer, and
a hard coating layer disposed on the base layer, and
the base layer includes an ester-based polymer and contains a silicon atom or a titanium atom.
